(19) United States
(12) Patent Application Publication
(10) Pub. No.: US 2019/0108804 A1
(43) Pub. Date: Apr. 11, 2019

(54) LIQUID CRYSTAL DISPLAY DEVICE AND METHOD OF CONTROLLING THE SAME

(71) Applicant: SHARP KABUSHIKI KAISHA, Sakai City, Osaka (JP)

(72) Inventors: TAKASHI SASAKI, Sakai City (JP); GOZO OZEKI, Sakai city (JP)

(21) Appl. No.: 16/088,429

(22) PCT Filed: Mar. 17, 2017
(86) PCT No.: PCT/JP2017/010844

§ 371 Date: Sep. 25, 2018

(30) Foreign Application Priority Data
Mar. 25, 2016 (JP) 2016-061171

(51) Int. Cl. G09G 3/36

(52) U.S. Cl. CPC G09G 3/3614; G09G 2310/08; G09G 2320/046; G09G 3/3696

(57) ABSTRACT

In a display control circuit (310) of a liquid crystal display device, there are provided: a polarity monitoring unit (315) configured to monitor a polarity signal (a signal for controlling a polarity of a liquid crystal application voltage) (POL) given to a liquid crystal panel drive circuit; and a polarity signal generation unit (314) configured to generate the polarity signal (POL) such that an increase in a polarity time difference (a difference between a length of a period during which a positive polarity voltage is applied to a liquid crystal and a length of a period during which a negative polarity voltage is applied to the liquid crystal) is suppressed on the basis of a polarity maintenance signal (PS) as a monitoring result produced by the polarity monitoring unit (315).

### TECHNICAL FIELD

The present invention relates to a liquid crystal display device, and more specifically, to a liquid crystal display device configured to display an image while changing a frame frequency, and to a method of controlling the same.

### BACKGROUND ART

Heretofore, a liquid crystal display device has been used for various purposes. The liquid crystal display device is a display device configured to display an image by transmitting/blocking light using properties of liquid crystal that arrangement of molecules changes when the molecules are applied with a voltage. Regarding such a liquid crystal display device, it is known that the liquid crystal deteriorates and screen burn-in occurs when a direct voltage is applied to the liquid crystal for a long time. Therefore, in the liquid crystal display device, AC drive in which a positive polarity voltage and a negative polarity voltage are alternately applied to the liquid crystal is performed. For example, as illustrated in FIG. 12, the polarity of the liquid crystal application voltage in each pixel is inverted every frame on the basis of a vertical synchronization signal Vsync. In a general liquid crystal display device, since a frame frequency is constant, deterioration of the liquid crystal is suppressed by the AC drive as described above. Regarding the vertical synchronization signal Vsync, actually, pulses having some width are outputted as indicated by reference numeral 91 in FIG. 11. However, since the pulse width corresponds to a very short time, the pulses are represented by line segments as indicated by reference numeral 92 in FIG. 13 in this explanation.

Incidentally, in recent years, the liquid crystal display device is sometimes used for a purpose of displaying images with rapid motion, for example, for game application. Generally, in the liquid crystal display device, screen rewriting (refreshing) is performed at a fixed frame frequency (for example, 60 Hz). However, since a moving image for the game is composed of various scenes such as scenes where the image changes drastically and scenes where the image changes less, an input frequency of an input image data varies when image data for the game is inputted as the input image data to the liquid crystal display device. For example, in a period during which a moving image for one game is being reproduced, the input frequency of the input image data becomes 120 Hz and 24 Hz. When the input frequency is variable as described above, it becomes impossible to synchronize the input of the input image data and rewriting of the screen, so that there may occur a phenomenon called “tearing” in which an image of a current frame and an image of a previous frame coexist in one display screen. Therefore, there has been proposed a synchronization technique called “G-SYNC” (“G-SYNC” is a registered trademark) for rewriting the screen each time of receiving input image data for one frame. In accordance with this synchronization technique, for example, when the input frequency of the input image data is 30 Hz, the frame frequency of the liquid crystal display device is also 30 Hz, and when the input frequency of the input image data is 60 Hz, the frame frequency of the liquid crystal display device is also 60 Hz. In this way, an occurrence of the tearing is prevented.

It should be noted that the following prior art documents are known in relation to the present invention. Japanese Laid-Open Patent Publication No. 2005-309274 discloses a technique for preventing pixel burn-in by inverting the polarity of a signal voltage by an inversion control signal when there occurs a pixel in which the AC drive is not established. Japanese Laid-Open Patent Publication No. 2011-123088 discloses a technique for correctly inverting the polarity between two consecutive frames even if the number of ineffective scanning lines changes. Japanese Laid-Open Patent Publication No. 2008-170466 discloses a technique for suppressing brightness of the screen from making variation when a common electrode is driven by the AC drive, the variation depending on the number of lines of an input video signal.

### PRIOR ART DOCUMENTS

### Patent Documents

[Patent Document 1] Japanese Laid-Open Patent Publication No. 2005-309274

[Patent Document 2] Japanese Laid-Open Patent Publication No. 2011-123088

[Patent Document 3] Japanese Laid-Open Patent Publication No. 2008-170466

### SUMMARY OF THE INVENTION

### Problems to be Solved by the Invention

However, in the liquid crystal display device adopting the above-mentioned synchronization technique called “G-SYNC”, the frame frequency varies depending on an input frequency of the input image data. Therefore, when the polarity of the liquid crystal application voltage is inverted every frame on the basis of the vertical synchronization signal Vsync, then as illustrated in FIG. 14 for example, a length of a period during which the positive polarity voltage is applied to the liquid crystal and a length of a period during which the negative polarity voltage is applied to the liquid crystal may be different from each other. In this way, in the liquid crystal display device configured to display the image while changing the frame frequency, the polarity of the liquid crystal application voltage is biased, and as a result, the burn-in occurs. Also regarding any of the techniques disclosed in the above-mentioned three patent documents (Japanese Laid-Open Patent Publication Nos. 2005-309274, 2011-123088 and 2008-170466), the occurrence of the burn-in caused by such variation of the frame frequency cannot be suppressed.

It is an object of the present invention to suppress the occurrence of the burn-in caused by the bias in the polarity of the liquid crystal application voltage in the liquid crystal display device configured to display the image while changing the frame frequency.

### Means for Solving the Problems

A first aspect of the present invention is directed to a liquid crystal display device having a liquid crystal panel including a liquid crystal as a display element, the liquid crystal display device being configured to display an image while changing a frame frequency depending on a change in an input frequency of input image data, the liquid crystal display device including:

a display control circuit configured to generate, based on the input image data, a video signal representing an image to be displayed on the liquid crystal panel, and configured to generate, depending on the input frequency of the input image data, a control signal including a polarity signal for controlling a polarity of a liquid crystal application voltage; and

a liquid crystal panel drive circuit configured to drive the liquid crystal panel such that a voltage corresponding to the video signal is applied to the liquid crystal, based on the video signal and the control signal that are generated by the display control circuit,

wherein the display control circuit includes a polarity adjustment unit configured to adjust the polarity of the liquid crystal application voltage so as to suppress an increase in a polarity time difference that is a difference between a length of a period during which a positive polarity voltage is applied to the liquid crystal and a length of a period during which a negative polarity voltage is applied to the liquid crystal.

According to a second aspect of the present invention, in the first aspect of the present invention,

the polarity adjustment unit includes:
a polarity monitoring unit configured to monitor the polarity signal given to the liquid crystal panel drive circuit to obtain the polarity time difference, and to output a monitoring result based on the obtained polarity time difference; and
a polarity signal generation unit configured to generate the polarity signal such that the increase in the polarity time difference is suppressed, based on the monitoring result outputted from the polarity monitoring unit.

According to a third aspect of the present invention, in the second aspect of the present invention,

when the polarity time difference becomes equal to or more than a first predetermined value, the polarity monitoring unit gives a polarity maintenance signal as the monitoring result to the polarity signal generation unit throughout a period at least until the polarity time difference becomes equal to or less than a second predetermined value, the polarity maintenance signal issuing an instruction to maintain the liquid crystal application voltage at one of a positive polarity and a negative polarity so as to reduce the polarity time difference, and

upon receiving the polarity maintenance signal, the polarity signal generation unit generates the polarity signal such that the voltage of the polarity indicated by the polarity maintenance signal is applied to the liquid crystal.

According to a fourth aspect of the present invention, in the second aspect of the present invention,

when the polarity time difference becomes equal to or more than a first predetermined value, the polarity monitoring unit intermittently gives a polarity maintenance signal as the monitoring result to the polarity signal generation unit during a period at least until the polarity time difference becomes equal to or less than a second predetermined value, the polarity maintenance signal issuing an instruction to maintain the liquid crystal application voltage at one of a positive polarity and a negative polarity so as to reduce the polarity time difference, and

upon receiving the polarity maintenance signal, the polarity signal generation unit generates the polarity signal such that the voltage of the polarity indicated by the polarity maintenance signal is applied to the liquid crystal.

According to a fifth aspect of the present invention, in the second aspect of the present invention,

the polarity monitoring unit obtains the polarity time difference at a frequency higher than a frame frequency.

According to a sixth aspect of the present invention, in the first aspect of the present invention,

timing at which a signal value of the polarity signal changes is synchronized with a vertical synchronization signal indicating timing of rewriting a display image on the liquid crystal panel.

According to a seventh aspect of the present invention, in the first aspect of the present invention,

the polarity adjustment unit includes:
a polarity control unit configured to output a polarity control signal that is a signal indicating the polarity of the liquid crystal application voltage and being set such that a period of indicating the positive polarity and a period of indicating the negative polarity appear alternately with a same length; and
a polarity signal generation unit configured to generate the polarity signal based on a signal value of the polarity control signal at a disclosing time of each frame.

An eighth aspect of the present invention is directed to a method for controlling a liquid crystal display device having a liquid crystal panel including a liquid crystal as a display element, the liquid crystal display device being configured to display an image while changing a frame frequency depending on a change in an input frequency of input image data, the method including:

a display control step of generating, based on the input image data, a video signal representing an image to be displayed on the liquid crystal panel, and generating, depending on the input frequency of the input image data, a control signal including a polarity signal for controlling a polarity of a liquid crystal application voltage; and

a liquid crystal panel drive step of driving the liquid crystal panel such that a voltage corresponding to the video signal is applied to the liquid crystal, based on the video signal and the control signal that are generated in the display control step,

wherein the display control step includes a polarity adjustment step of adjusting the polarity of the liquid crystal application voltage so as to suppress an increase in a polarity time difference that is a difference between a length of a period during which a positive polarity voltage is applied to the liquid crystal and a length of a period during which a negative polarity voltage is applied to the liquid crystal.

### Effects of the Invention

According to the first aspect of the present invention, the polarity adjustment unit provided in the display control circuit adjusts the polarity of the liquid crystal application voltage such that the bias in the polarity of the liquid crystal application voltage is suppressed from increasing. Therefore, even when the frame frequency is changed in accordance with the change in the input frequency of the input image data, the occurrence of the bias in the polarity of the liquid crystal application voltage due to the variation in the length of the frame is suppressed. That is, even if the image display is performed while changing the frame frequency, the occurrence of the burn-in is suppressed. From the above, the occurrence of the burn-in caused by the bias in the polarity of the liquid crystal application voltage is suppressed in the liquid crystal display device configured to display the image while changing the frame frequency.

According to the second aspect of the present invention, the polarity signal is controlled by monitoring the polarity signal given to the liquid crystal panel drive circuit, and accordingly, a large bias is surely suppressed from occurring in the polarity of the liquid crystal application voltage.

According to the third aspect of the present invention, even if the polarity of the liquid crystal application voltage is biased, the voltage is applied to the liquid crystal so as to eliminate the bias.

According to the fourth aspect of the present invention, the same polarity voltage is prevented from being applied to the liquid crystal continuously for a long time. Thus, a viewer is suppressed from feeling discomfort to the display (for example, an occurrence of flushing) is suppressed.

According to the fifth aspect of the present invention, the period during which the polarity of the liquid crystal application voltage is biased is suppressed from becoming long.

According to the sixth aspect of the present invention, the polarity inversion of the liquid crystal application voltage is performed at the time of frame switching. Therefore, good display quality is obtained.

According to the seventh aspect of the present invention, the polarity signal for controlling the polarity of the liquid crystal application voltage is generated on the basis of the polarity control signal that is set such that the period of indicating the positive polarity and the period of indicating the negative polarity alternately appear with the same length. For this reason, the polarity inversion of the liquid crystal application voltage is performed before the bias in the polarity of the liquid crystal application voltage increases. Therefore, the occurrence of the burn-in caused by the bias in the polarity of the liquid crystal application voltage is suppressed effectively in the liquid crystal display device configured to display the image while changing the frame frequency.

According to the eighth aspect of the present invention, the same effect as the first aspect of the present invention can be exhibited in the method for controlling the liquid crystal display device.

### BRIEF DESCRIPTION OF THE DRAWINGS

FIG. 1 is a block diagram illustrating a configuration of a display control circuit in a first embodiment of the present invention.

FIG. 2 is a block diagram illustrating an overall configuration of a liquid crystal display device according to the first embodiment.

FIG. 3 is a block diagram illustrating a configuration example of a source driver according to the first embodiment.

FIG. 4 is a diagram for explaining control of a level of a polarity signal when a polarity maintenance signal is not given to a polarity signal generation unit in the first embodiment.

FIG. 5 is a diagram for explaining control of the level of the polarity signal when the polarity maintenance signal is given to the polarity signal generation unit in the first embodiment.

FIG. 6 is a diagram for explaining the control of the level of the polarity signal when the polarity maintenance signal is given to the polarity signal generation unit in the first embodiment.

FIG. 7 is a diagram for explaining a specific example of a polarity control method in the first embodiment.

FIG. 8 is a diagram for explaining a case where a short frame and a long frame are alternately repeated in a conventional example.

FIG. 9 is a diagram for explaining a specific example of a polarity control method in a modification of the first embodiment.

FIG. 10 is a block diagram illustrating a configuration of a display control circuit in a second embodiment of the present invention.

FIG. 11 is a diagram for explaining a specific example of a polarity control method in the second embodiment.

FIG. 12 is a diagram for explaining AC drive in a general liquid crystal display device.

FIG. 13 is a diagram for explaining expression of a waveform of a vertical synchronization signal.

FIG. 14 is a diagram for explaining that a bias occurs in a polarity of a liquid crystal application voltage in a liquid crystal display device configured to display an image while changing a frame frequency.

### MODES FOR CARRYING OUT THE INVENTION

### 0. Regarding Terms

Before describing embodiments of the present invention, terms for use in this specification will be explained. A difference between a length of a period during which a positive polarity voltage is applied to liquid crystal and a length of a period during which a negative polarity voltage is applied to the liquid crystal is referred to as a “polarity time difference”. The polarity time difference is an absolute value of a value obtained by subtracting one of the lengths from the other of the lengths. The polarity time difference is “0” or a positive value. The value obtained by subtracting the length of the period during which the negative polarity voltage is applied to the liquid crystal from the length of the period during which the positive polarity voltage is applied to the liquid crystal is referred to as a “polarity bias value”. The polarity bias value is “0” or a positive or negative value. The polarity time difference is equal to an absolute value of this polarity bias value. If the period during which the positive polarity voltage is applied to the liquid crystal is longer than the period during which the negative polarity voltage is applied to the liquid crystal, then the polarity bias value is a positive value. If the period during which the negative polarity voltage is applied to the liquid crystal is longer than the period during which the positive polarity voltage is applied to the liquid crystal, then the polarity bias value is a negative value. If the length of the period during which the positive polarity voltage is applied to the liquid crystal and the length of the period during which the negative polarity voltage is applied to the liquid crystal are equal to each other, then the polarity bias value is “0”.

Regarding the polarity time difference and the polarity bias value, a length corresponding to a period length of a certain frame (referred to as a “frame A”) is “1” in each of the following embodiments. For example, if the period during which the negative polarity voltage is applied to the liquid crystal is longer than the period during which the positive polarity voltage is applied to the liquid crystal by a period corresponding to three times the period length of the frame A, then the polarity time difference is “3”, and the polarity bias value is “−3”.

Embodiments of the present invention will be described below with reference to the accompanying drawings.

### 1. First Embodiment

<1.1 Overall Configuration and Operation Outline>

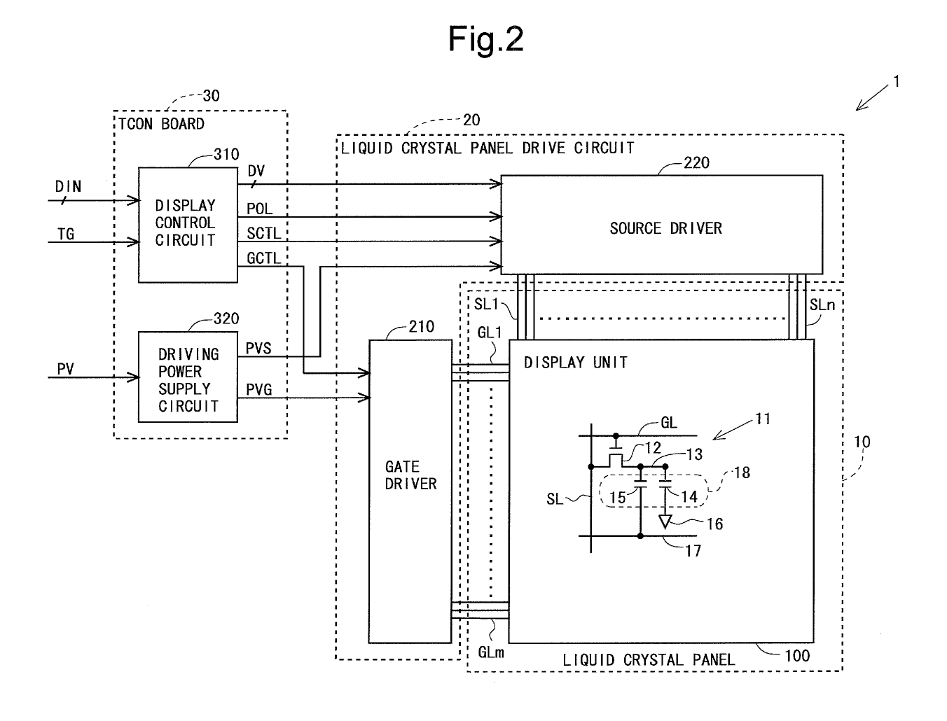

FIG. 2 is a block diagram illustrating an overall configuration of a liquid crystal display device 1 according to a first embodiment of the present invention. The liquid crystal display device 1 includes: a liquid crystal panel 10 including a display unit 100; a liquid crystal panel drive circuit 20 configured to drive the liquid crystal panel 10; a display control circuit 310 configured to control an operation of the liquid crystal panel drive circuit 20; and a driving power supply circuit 320 configured to supply a power supply voltage to the liquid crystal panel drive circuit 20. The liquid crystal panel drive circuit 20 includes a gate driver 210 and a source driver 220.

The display control circuit 310 and the driving power supply circuit 320 are mounted on a TCON board 30 in the form of an IC. The liquid crystal panel 10 includes two glass substrates (an array substrate and a color filter substrate). A known method such as a TAB method, a COG method, and a COF method can be adopted as a method for mounting an IC as the gate driver 210 and an IC as the source driver 220. Moreover, one or both of the gate driver 210 and the source driver 220 may be monolithically formed on the glass substrate constituting the liquid crystal panel 10.

Referring to FIG. 2, a plurality of (n) source bus lines (video signal lines) SL1 to SLn and a plurality of (m) gate bus lines (scanning signal lines) GL1 to GLm are arranged in the display unit 100. Pixel forming portions 11 configured to form pixels are provided corresponding to respective intersections of the source bus lines SL1 to SLn and the gate bus lines GL1 to GLm. That is, the display unit 100 includes a plurality of (nxm) pixel forming portions 11. The plurality of pixel forming portions 11 are arranged in a matrix form to constitute a pixel matrix of m rows×n columns. Each of the pixel forming portions 11 includes: a thin film transistor (TFT) 12 that is a switching element in which a gate terminal is connected to the gate bus line GL passing through the corresponding intersection and a source terminal is connected to the source bus line SL passing through the intersection; a pixel electrode 13 connected to a drain terminal of the TFT 12; a common electrode 16 and an auxiliary capacitance electrode 17 which are commonly provided to the plurality of pixel forming portions 11; a liquid crystal capacitance formed of the pixel electrode 13 and the common electrode 16; and an auxiliary capacitance 15 formed of the pixel electrode 13 and the auxiliary capacitance electrode 17. The liquid crystal capacitance 14 and the auxiliary capacitance 15 constitute a pixel capacitance 18. In the display unit 100 in FIG. 2, only components corresponding to one pixel forming portion 11 are illustrated.

Liquid crystal as a display element is sandwiched between the pixel electrode 13 and the common electrode 16, and alignment of molecules of the liquid crystal changes depending on a magnitude of the liquid crystal application voltage, and an amount of light transmission changes. A desired image is displayed on the display unit 100 by setting the liquid crystal application voltage to a magnitude corresponding to a target display image in each pixel forming portion 11.

Incidentally, as the TFT 12 in the display unit 100, for example, an oxide TFT (a thin film transistor having an oxide semiconductor layer) can be adopted. The oxide semiconductor layer is formed, for example, of an oxide semiconductor film including an In-Ga-Zn-O-based semiconductor (for example, indium gallium zinc oxide) that is a ternary oxide of indium (In), gallium (Ga), and zinc (Zn). Note that the present invention does not exclude use of TFTs other than the oxide TFT.

An operation outline of the components illustrated in FIG. 2 will be described. The display control circuit 310 receives input image data DIN and a timing signal group TG such as a horizontal synchronization signal and a vertical synchronization signal, and outputs a digital video signal DV, a polarity signal POL for controlling the polarity of the liquid crystal application voltage, a source control signal SCTL for controlling the operation of the source driver 220, and a gate control signal GCTL for controlling the operation of the gate driver 210. With such a configuration, the polarity signal POL, the source control signal SCTL, and the gate control signal GCTL are generated depending on an input frequency of the input image data DIN. Typically, the source control signal SCTL includes a source start pulse signal, a source clock signal, a latch strobe signal, and the like. In addition, the gate control signal GCTL typically includes a gate start pulse signal, a gate clock signal, and the like. The input image data DIN and the timing signal group TG are given to the display control circuit 310 from an image processing unit called, for example, a GPU.

The driving power supply circuit 320 receives a power supply voltage PV, and generates a power supply voltage PVG for the operation of the gate driver 210 and a power supply voltage PVS for the operation of the source driver 220, for example, by an internal DC-DC converter.

The gate driver 210 receives the gate control signal GCTL outputted from the display control circuit 310 and the power supply voltage PVG outputted from the driving power supply circuit 320, and repeatedly applies an active scanning signal to each gate bus line GL with one vertical scanning period as a cycle.

The source driver 220 receives the digital video signal DV, the polarity signal POL, the source control signal SCTL, which are outputted from the display control circuit 310, and the power supply voltage PVS outputted from the driving power supply circuit 320, and applies a driving video signal to each source bus line SL in order to charge the pixel capacitance 18 of each pixel forming portion 11 in the display unit 100. A detailed configuration of the source driver 220 will be described later.

As described above, the scanning signals are applied to the gate bus lines GL1 to GLm, and the driving video signals are applied to the source bus lines SL1 to SLn, so that an image based on the input image data DIN is displayed on the display unit 100.

<1.2 Configuration and Operation of Source Driver>

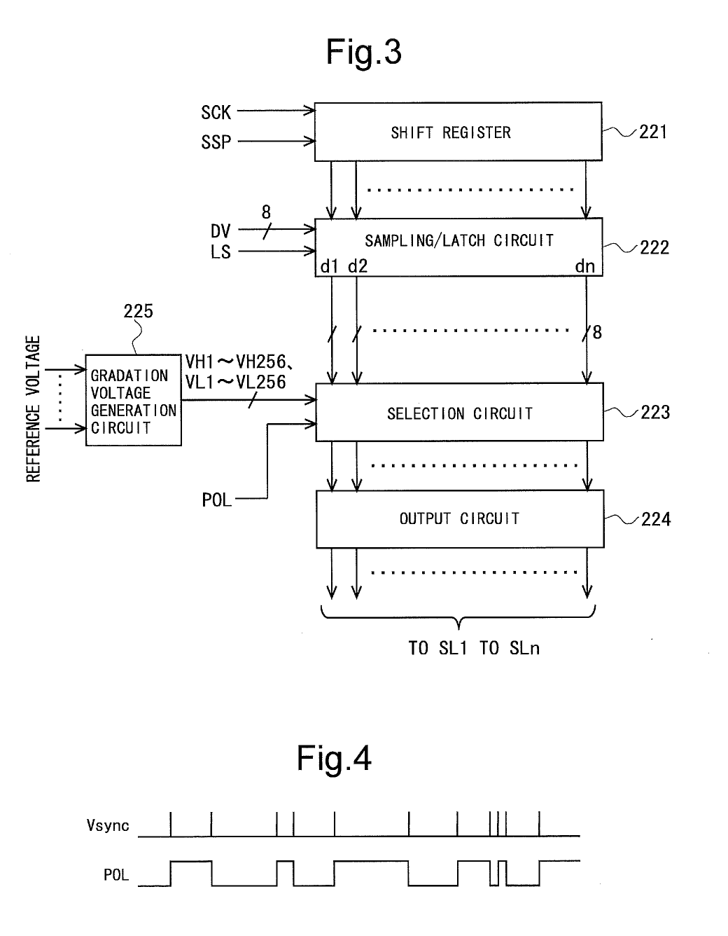

FIG. 3 is a block diagram illustrating a configuration example of the source driver 220 in the present embodiment. Here, it is assumed that gradation expression of 256 gradations is possible. The source driver 220 includes: an n-stage shift register 221; a sampling/latch circuit 222 configured to output 8-bit internal image signals dl to do corresponding to the source bus lines SL1 to SLn; a selection circuit 223 configured to select voltages to be applied to the respective source bus lines SL1 to SLn; an output circuit 224 configured to apply, as driving video signals, the voltages selected by the selection circuit 223 to the source bus lines SL1 to SLn; and a gradation voltage generation circuit 225 configured to output voltages respectively corresponding to 256 gradation levels in the positive polarity and the negative polarity. In addition to the digital video signal DV and the polarity signal POL, a source start pulse signal SSP, a source clock signal SCK, and a latch strobe signal LS are applied as the source control signal SCTL to the source driver 220.

The source start pulse signal SSP and the source clock signal SCK are inputted to the shift register 221. The shift register 221 sequentially transfers a pulse included in the source start pulse signal SSP from an input end to an output end based on the source clock signal SCK. In response to this pulse transfer, sampling pulses corresponding to the source bus lines SL1 to SLn are sequentially outputted from the shift register 221, and the sampling pulses are sequentially inputted to the sampling/latch circuit 222.

The sampling/latch circuit 222 samples and holds the 8-bit digital video signal DV sent from the display control circuit 310 at timing of the sampling pulse outputted from the shift register 221. Moreover, the sampling/latch circuit 222 simultaneously outputs the held digital video signal DV as 8-bit internal image signals dl to dn at timing of the pulse of the latch strobe signal LS.

The gradation voltage generation circuit 225 generates voltages (gradation voltages) VH1 to VH256 and VL1 to VL256 corresponding to 256 gradation levels for each of the positive polarity and the negative polarity on the basis of a plurality of reference voltages given from a predetermined power supply circuit (not shown), and outputs the generated gradation voltages as gradation voltage groups.

On the basis of the internal image signals dl to dn outputted from the sampling/latch circuit 222, the selection circuit 223 selects one voltage of the gradation voltage groups VH1 to VH256 and VL1 to VL256 outputted from the gradation voltage generation circuit 225, and outputs the selected voltage. At this time, the polarity of the voltage to be selected from the gradation voltage groups is determined on the basis of the polarity signal POL sent from the display control circuit 310. The voltage outputted from the selection circuit 223 is inputted to the output circuit 224.

The output circuit 224 performs impedance conversion for the voltage outputted from the selection circuit 223, and outputs the converted voltage as a driving video signal to the source bus lines SL1 to SLn.

<1.3 Configuration of Display Control Circuit>

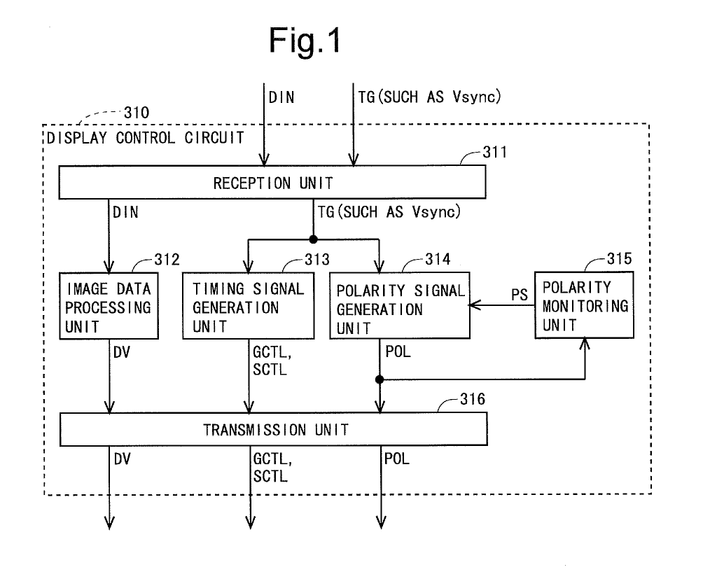

FIG. 1 is a block diagram illustrating a configuration of the display control circuit 310 according to the present embodiment. The display control circuit 310 includes a reception unit 311, an image data processing unit 312, a timing signal generation unit 313, a polarity signal generation unit 314, a polarity monitoring unit 315, and a transmission unit 316.

The reception unit 311 receives the input image data DIN and the timing signal group TG which are sent from the outside. The timing signal group TG includes at least the vertical synchronization signal Vsync. The image data processing unit 312 receives the input image data DIN and performs, for example, a correction process for suppressing an occurrence of display unevenness and a correction process for overdrive driving for suppressing deterioration in image quality at the time of moving image display, and thereby generates the digital video signal DV. The timing signal generation unit 313 generates the above-mentioned source control signal SCTL and gate control signal GCTL on the basis of the timing signal group TG.

The polarity signal generation unit 314 generates the polarity signal POL that controls the polarity of the liquid crystal application voltage on the basis of the vertical synchronization signal Vsync included in the timing signal group TG. At that time, the polarity signal generation unit 314 also takes into account a polarity maintenance signal PS described later that is outputted from the polarity monitoring unit 315. In the present embodiment, during a period while the polarity signal POL is at a high level, a positive polarity voltage is applied to the liquid crystal, and during a period while the polarity signal POL is at a low level, a negative polarity voltage is applied to the liquid crystal. In other words, when the positive polarity voltage is to be applied to the liquid crystal, the polarity signal generation unit 314 sets the level of the polarity signal POL to the high level, and when the negative polarity voltage is to be applied to the liquid crystal, the polarity signal generation unit 314 sets the level of the polarity signal POL to the low level.

As described above, during the period in which the polarity signal POL is at the high level, the positive polarity voltage is applied to the liquid crystal, and during the period while the polarity signal POL is at the low level, the negative polarity voltage is applied to the liquid crystal. Accordingly, on the basis of the polarity signal POL, it is possible to obtain the above-mentioned polarity bias value and polarity time difference. Therefore, the polarity monitoring unit 315 monitors the polarity signal POL outputted from the polarity signal generation unit 314 (that is, the polarity signal POL given to the liquid crystal panel drive circuit 20), thereby obtaining the polarity bias value and the polarity time difference. More specifically, in the polarity monitoring unit 315, a counter circuit is provided where the number is obtained by checking the level of the polarity signal POL every certain period (every period corresponding to the period length of the above-mentioned frame A) and by subtracting the number of times that the level is the low level from the number of times that the level is the high level, and the obtained number is outputted as a count value. The count value outputted from this counter circuit is the polarity bias value. Since the polarity time difference is equal to the absolute value of the polarity bias value, the polarity monitoring unit 315 can easily obtain the polarity time difference from the polarity bias value.

On the basis of the polarity time difference obtained as described above, the polarity monitoring unit 315 outputs the polarity maintenance signal PS as a monitoring result. The polarity maintenance signal PS is a signal for instructing the polarity signal generation unit 314 to maintain the liquid crystal application voltage at either the positive polarity or the negative polarity such that the polarity time difference is small. For convenience of explanation, the signal issuing an instruction to maintain the liquid crystal application voltage at the positive polarity in the polarity maintenance signal PS is referred to as a “positive polarity maintenance signal”, and the signal issuing an instruction to maintain the liquid crystal application voltage at the negative polarity in the polarity maintenance signal PS is referred to as a “negative polarity maintenance signal”. Reference symbol PS(m) is assigned to the positive polarity maintenance signal, and reference symbol PS(m) is assigned to the negative polarity maintenance signal.

Incidentally, the polarity maintenance signal PS is outputted from the polarity monitoring unit 315 when the polarity time difference becomes equal to or longer than a predetermined time. A value representing a length of a predetermined time to be compared with the polarity time difference is referred to as a “first predetermined value” for convenience of explanation. When the polarity time difference becomes equal to or more than the first predetermined value, if the polarity bias value is a positive value (that is, if the polarity is biased toward the positive polarity), the negative polarity maintenance signal PS(m) is outputted from the polarity monitoring unit 315, and if the polarity bias value is a negative value (that is, if the polarity is biased toward the negative polarity), the positive polarity maintenance signal PS(p) is outputted from the polarity monitoring unit 315.

The output of the polarity maintenance signal PS from the polarity monitoring unit 315 is maintained at least until the polarity time difference becomes equal to or shorter than a predetermined time. A value representing a length of a predetermined time is referred to as a “second predetermined value” for convenience of explanation. Since the polarity time difference is equal to the absolute value of the polarity bias value as mentioned above, the output of the polarity maintenance signal PS is maintained until the absolute value of the count value (=polarity bias value) outputted from the above-mentioned counter circuit becomes equal to or less than the second predetermined value.

As described above, the polarity monitoring unit 315 monitors the polarity signal POL to obtain the polarity time difference, and when the obtained polarity time difference becomes equal to or more than the first predetermined value, the polarity monitoring unit 315 outputs a polarity maintenance signal PS issuing an instruction to maintain the liquid crystal application voltage at either the positive polarity or the negative polarity so as to reduce the polarity time difference throughout a period at least until the polarity time difference becomes equal to or less than the second predetermined value.

Upon receiving the polarity maintenance signal PS, the polarity signal generation unit 314 controls the level of the polarity signal POL such that a voltage having the polarity indicated by the polarity maintenance signal PS is applied to the liquid crystal. Specifically, upon receiving the positive polarity maintenance signal PS(p), the polarity signal generation unit 314 sets the level of the polarity signal POL to the high level such that a positive polarity voltage is applied to the liquid crystal. Meanwhile, upon receiving the negative polarity maintenance signal PS(m), the polarity signal generation unit 314 sets the level of the polarity signal POL to the low level such that a negative polarity voltage is applied to the liquid crystal. The polarity signal POL generated by the polarity signal generation unit 314 as described above is sent to the source driver 220 via the transmission unit 316.

The transmission unit 316 transmits the gate control signal GCTL generated by the timing signal generation unit 313 to the gate driver 210, and transmits, to the source driver 220, the digital video signal DV generated by the image data processing unit 312, the source control signal SCTL generated by the timing signal generation unit 313, and the polarity signal POL generated by the polarity signal generation unit 314.

In the present embodiment, the polarity signal generation unit 314 and the polarity monitoring unit 315 realize a polarity adjustment unit. That is, the display control circuit 310 in the present embodiment includes the polarity signal generation unit 314 and the polarity monitoring unit 315 as the polarity adjustment unit configured to adjust the polarity of the liquid crystal application voltage so as to suppress an increase in the polarity time difference that is a difference between the length of the period during which the positive polarity voltage is applied to the liquid crystal and the length of the period during which the negative polarity voltage is applied to the liquid crystal.

<1.4 Polarity Control Method>

Next, a method for controlling the polarity of the liquid crystal application voltage will be described in detail. Note that, while the polarity signal POL can take two states (high level and low level), here, changing the level of the polarity signal POL is referred to as “inverting the level of the polarity signal POL”.

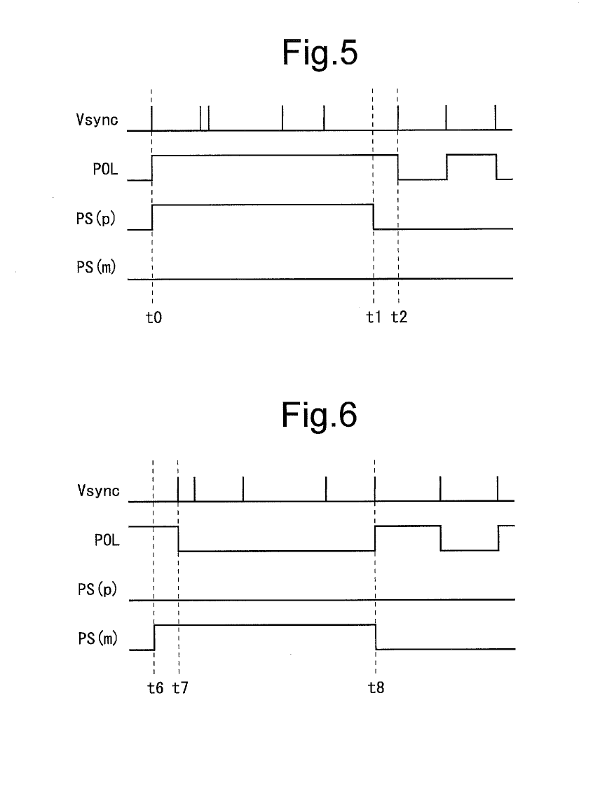

In the polarity signal generation unit 314, the level of the polarity signal POL to be generated is controlled as follows depending on whether the polarity maintenance signal PS is given from the polarity monitoring unit 315. When the polarity maintenance signal PS is not given to the polarity signal generation unit 314, the polarity signal generation unit 314 inverts the level of the polarity signal POL every time the vertical synchronization signal Vsync is inputted, as illustrated in FIG. 4. Meanwhile, when the polarity maintenance signal PS is given to the polarity signal generation unit 314, as illustrated in FIGS. 5 and 6, the polarity signal generation unit 314 maintains the level of the polarity signal POL at a level corresponding to the polarity indicated by the polarity maintenance signal PS during a period from the time when the vertical synchronization signal Vsync is first inputted after the polarity maintenance signal PS is given until the time when the vertical synchronization signal Vsync is first inputted after the output of the polarity maintenance signal PS is stopped.

It should be noted that FIG. 5 illustrates an example in which the positive polarity maintenance signal PS(p) is given to the polarity signal generation unit 314 in a period from a time point t0 to a time point t1, and FIG. 6 illustrates an example in which the negative polarity maintenance signal PS(m) is given to the polarity signal generation unit 314 in a period from a time point t6 to a time point t8. In the example illustrated in FIG. 5, the vertical synchronization signal Vsync is also inputted at the same timing as a rising edge of the positive polarity maintenance signal PS(p), and the level of the polarity signal POL is inverted at that timing (time point t0). Moreover, in the example illustrated in FIG. 5, the vertical synchronization signal Vsync is not inputted at timing (time point tl) of a falling edge of the positive polarity maintenance signal PS(p), and the level of the polarity signal POL is inverted at timing (time point t2) when the vertical synchronization signal Vsync is first inputted after the time point tl. In the example illustrated in FIG. 6, the vertical synchronization signal Vsync is not inputted at timing (time point t6) of a rising edge of the negative polarity maintenance signal PS(m), and the level of the polarity signal POL is inverted at timing (time point t7) when the vertical synchronization signal Vsync is first inputted after the time point t6. Moreover, in the example illustrated in FIG. 6, the vertical synchronization signal Vsync is also inputted at the same timing as a falling edge of the negative polarity maintenance signal PS(m), and the level of the polarity signal POL is inverted at that timing (time point t8).

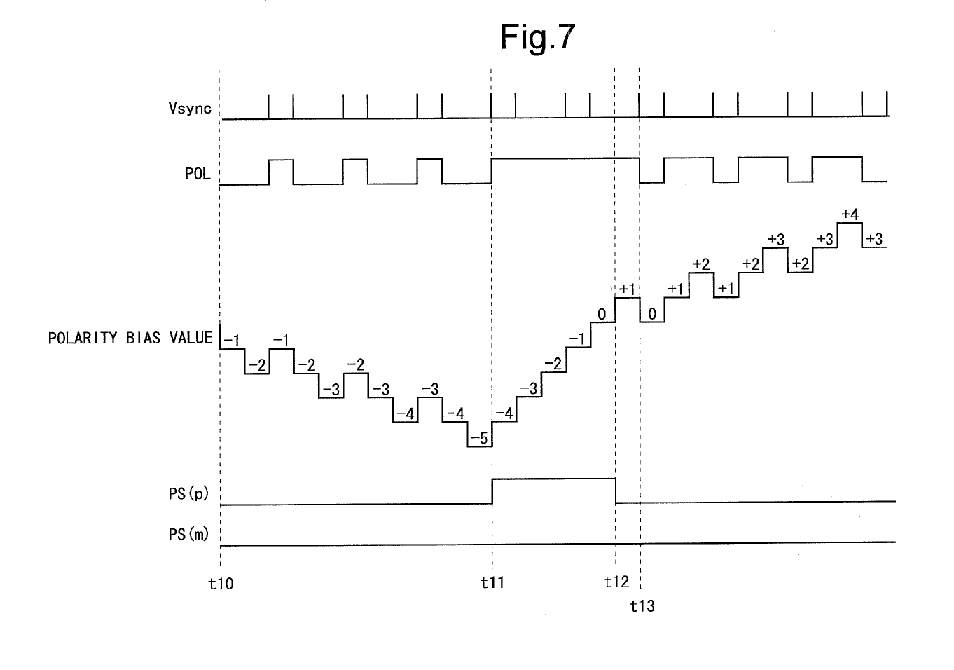

Here, a specific example of such a polarity control method in the present embodiment will be described with reference to FIG. 7. Here, it is assumed that the vertical synchronization signal Vsync is inputted such that a relatively short frame (referred to as a “short frame” for convenience) and a relatively long frame (referred to as a “long frame” for convenience) are alternately repeated. It is also assumed that the length of the long frame is twice the length of the short frame and that the short frame corresponds to the frame A mentioned above. That is, the polarity bias value increases or decreases for each period length of the short frame. Moreover, it is assumed that the above-mentioned first predetermined value is set to “5” and that the above-mentioned second predetermined value is set to “0”. That is, when the polarity time difference becomes 5 or more, the positive polarity maintenance signal PS(p) or the negative polarity maintenance signal PS(m) is outputted from the polarity monitoring unit 315 depending on whether a polarity return value is a positive value or a negative value. Moreover, when the polarity time difference becomes “0” after the output of the polarity maintenance signal PS, the output of the polarity maintenance signal PS is stopped.

In this example, first, the level of the polarity signal POL is at the low level in the long frame, and the level of the polarity signal POL is at the high level in the short frame. In other words, the liquid crystal application voltage is negative polarity in the long frame, and the liquid crystal application voltage is positive polarity in the short frame. Therefore, after a time point t10, the bias in the polarity of the liquid crystal application voltage gradually increases toward the negative polarity. Then, at a time point tll, the polarity bias value becomes “−5”. That is, at the time point t11, the polarity time difference becomes “5”. As a result, the polarity monitoring unit 315 outputs the positive polarity maintenance signal PS(p) issuing an instruction to maintain the liquid crystal application voltage at the positive polarity.

As described above, the polarity signal generation unit 314 receives the positive polarity maintenance signal PS(p) at the time point t11. Moreover, at the time point t11, the vertical synchronization signal Vsync is inputted. Therefore, the polarity signal generation unit 314 inverts the level of the polarity signal POL from the low level to the high level at the time point t11. Since the output of the polarity maintenance signal PS(p) is maintained until the polarity time difference reaches “0”, the bias in the polarity of the liquid crystal application voltage gradually decreases after the time point t11.

At a time point t12, the polarity bias value becomes “0”. That is, at the time point t12, the polarity time difference becomes “0”. As a result, the polarity monitoring unit 315 stops outputting the positive polarity maintenance signal PS(p). Then, at a time point t13 when the vertical synchronization signal Vsync is first inputted after the time point t12, the polarity signal generation unit 314 inverts the level of the polarity signal POL from the high level to the low level. Thereafter, until the polarity time difference reaches “5” again, the polarity signal generation unit 314 inverts the level of the polarity signal POL every time the vertical synchronization signal Vsync is inputted.

Preferably, the polarity monitoring unit 315 obtains the polarity time difference at a frequency higher than the frame frequency. In other words, preferably, the output of the count value (=polarity bias value) from the counter circuit provided in the polarity monitoring unit 315 is performed at a cycle sufficiently faster than the cycle at which the vertical synchronization signal Vsync is inputted. This is because, if the cycle of the output of the count value is longer, then the increase or decrease of the count value is slowly performed, and the period during which the polarity of the liquid crystal application voltage is biased becomes long.

The polarity maintenance signal PS may be outputted asynchronously with the vertical synchronization signal Vsync as illustrated in FIG. 6 for example. However, in order to maintain good display quality, preferably, the timing at which the level of the polarity signal POL is inverted is synchronized with the vertical synchronization signal Vsync.

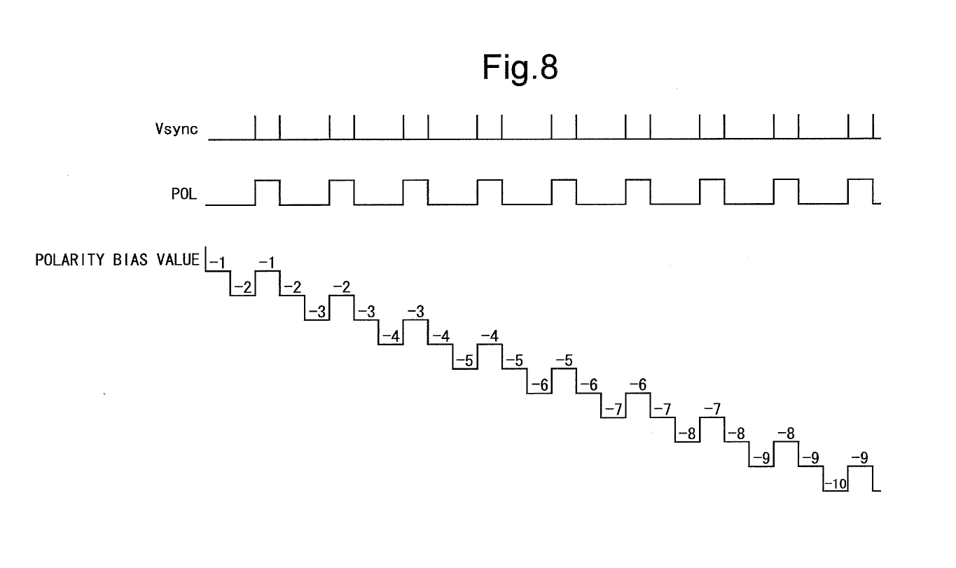

Incidentally, if the short frame and the long frame are alternately repeated in the conventional example, then since the level of the polarity signal POL is inverted every frame (every time the vertical synchronization signal Vsync is inputted) irrespective of the length of the frame period, the bias in the polarity of the liquid crystal application voltage increases with the lapse of time as illustrated in FIG. 8. For this reason, the burn-in occurs. In contrast, in the present embodiment, the bias in the polarity of the liquid crystal application voltage is suppressed, so that the occurrence of the burn-in is suppressed.

<1.5 Effect>

According to the present embodiment, in the display control circuit 310 of the liquid crystal display device 1, there are provided: the polarity monitoring unit 315 configured to monitor the polarity signal (a signal for controlling the polarity of the liquid crystal application voltage) POL given to the liquid crystal panel drive circuit 20; and the polarity signal generation unit 314 configured to generate the polarity signal POL, on the basis of a monitoring result produced by the polarity monitoring unit 315, such that the increase in the polarity time difference (the difference between the length of the period during which the positive polarity voltage is applied to the liquid crystal and the period during which the negative polarity voltage is applied to the liquid crystal) is suppressed. More specifically, when the polarity time difference becomes equal to or larger than a certain magnitude, the polarity monitoring unit 315 gives the polarity signal generation unit 314 the polarity maintenance signal PS issuing an instruction to maintain the liquid crystal application voltage at the positive polarity or an instruction to maintain the liquid crystal application voltage at the negative polarity. Then, the polarity signal generation unit 314 maintains the level of the polarity signal POL at the level corresponding to the polarity indicated by the polarity maintenance signal PS until the polarity time difference becomes equal to or less than a certain magnitude. As a result, even if the polarity of the liquid crystal application voltage is biased, a voltage is applied to the liquid crystal so as to eliminate the bias. Therefore, even when the frame frequency is changed in accordance with the change in the input frequency of the input image data DIN, the occurrence of the bias in the polarity of the liquid crystal application voltage due to the variation in the length of the frame is suppressed. That is, even if the image display is performed while changing the frame frequency, the occurrence of the burn-in is suppressed. As described above, according to the present embodiment, the occurrence of the burn-in caused by the bias in the polarity of the liquid crystal application voltage is suppressed in the liquid crystal display device 1 configured to display the image while changing the frame frequency.

<1.6 Modification>

In the first embodiment, when the polarity time difference becomes equal to or more than the first predetermined value and the polarity maintenance signal PS is outputted from the polarity monitoring unit 315, then the output of the polarity maintenance signal PS is maintained throughout the period at least until the polarity time difference becomes equal to or less than the second predetermined value. However, the present invention is not limited to this, and the output of the polarity maintenance signal PS from the polarity monitoring unit 315 may be intermittently performed.

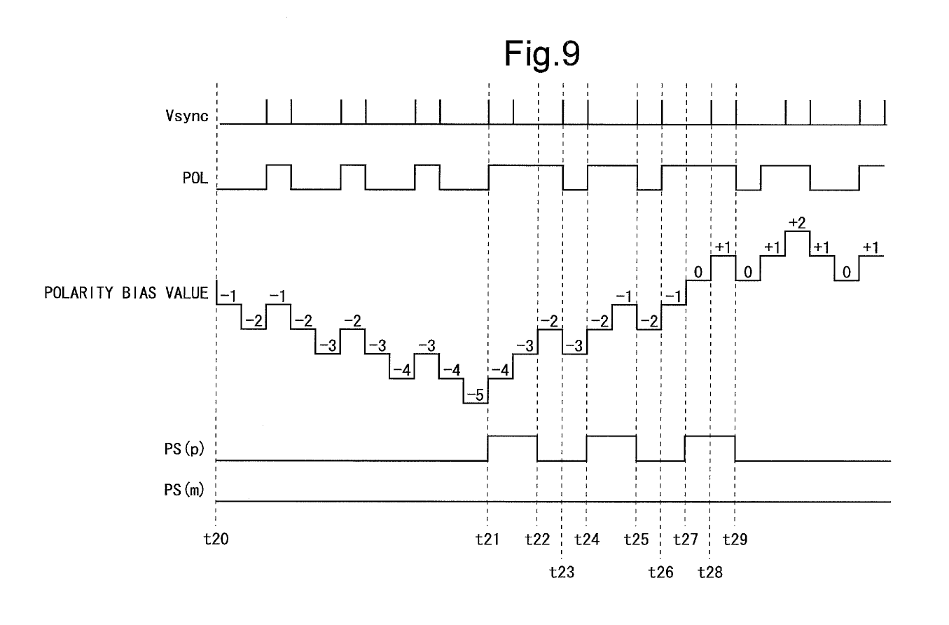

In the present modification, when the polarity time difference becomes equal to or more than the first predetermined value, then the polarity monitoring unit 315 intermittently gives the polarity maintenance signal PS to the polarity signal generation unit 314 during the period at least until the polarity time difference becomes equal to or less than the second predetermined value. Hereinafter, a specific example of a polarity control method in the present modification will be described with reference to FIG. 9. As in the first embodiment, it is assumed that the vertical synchronization signal Vsync is inputted such that the short frame and the long frame are alternately repeated. Moreover, as in the first embodiment, it is assumed that the first predetermined value is set to “5” and that the second predetermined value is set to “0”. Furthermore, regarding the intermittent output of the polarity maintenance signal PS, it is assumed that the polarity monitoring unit 315 is configured such that the output and stop of the polarity maintenance signal PS are alternately performed every period corresponding to twice the length of the short frame.

In this example, first, as in the first embodiment (see FIG. 7), the bias in the polarity of the liquid crystal application voltage gradually increases toward the negative polarity after a time point t20. Then, at a time point t21, the polarity bias value becomes “−5”. That is, at the time point t21, the polarity time difference becomes “5”. As a result, the polarity monitoring unit 315 outputs the positive polarity maintenance signal PS(p) issuing an instruction to maintain the liquid crystal application voltage at the positive polarity.

As described above, the polarity signal generation unit 314 receives the positive polarity maintenance signal PS(p) at the time point t21. Moreover, at the time point t21, the vertical synchronization signal Vsync is inputted. Therefore, the polarity signal generation unit 314 inverts the level of the polarity signal POL from the low level to the high level at the time point t21. As a result, the positive polarity voltage is applied to the liquid crystal, and accordingly, the bias in the polarity of the liquid crystal application voltage gradually decreases.

At a time point t22, the polarity monitoring unit 315 stops outputting the positive polarity maintenance signal PS(p). Since the vertical synchronization signal Vsync is not inputted at this time point t22, the level of the polarity signal POL is maintained at the high level. Then, at a time point t23 when the vertical synchronization signal Vsync is first inputted after the time point t22, the polarity signal generation unit 314 inverts the level of the polarity signal POL from the high level to the low level. As a result, the negative polarity voltage is applied to the liquid crystal.

At a time point t24, the polarity monitoring unit 315 resumes the output of the positive polarity maintenance signal PS(p). Since the vertical synchronization signal Vsync is inputted at the time point t24, the polarity signal generation unit 314 inverts the level of the polarity signal POL from the low level to the high level at the time point t24. As a result, the positive polarity voltage is applied to the liquid crystal, and accordingly, the bias in the polarity of the liquid crystal application voltage gradually decreases.

At a time point t25, the polarity monitoring unit 315 stops outputting the positive polarity maintenance signal PS(p). Since the vertical synchronization signal Vsync is inputted at the time point t25, the polarity signal generation unit 314 inverts the level of the polarity signal POL from the high level to the low level at the time point t25. Moreover, since the vertical synchronization signal Vsync is inputted at a time point t26, the polarity signal generation unit 314 inverts the level of the polarity signal POL from the low level to the high level.

At a time point t27, the polarity monitoring unit 315 resumes the output of the positive polarity maintenance signal PS(p). At this time, the level of the polarity signal POL is already at the high level, and the level of the polarity signal POL is maintained at the high level even after the time point t27. Thereafter, at a time point 28, the polarity bias value becomes “0”. That is, at the time point t28, the polarity time difference becomes “0”. As a result, the output of the positive polarity maintenance signal PS(p) is stopped at a time point t29 after the lapse of a period corresponding to twice the length of the short frame from the time point t27, and the intermittent output of the positive polarity maintenance signal PS(p) after the time point t21 is ended.

In the first embodiment, for example, when the polarity bias value becomes “−5”, the positive polarity voltage is continuously applied to the liquid crystal throughout the period during which the polarity bias value changes from “−5” to “0” (see FIG. 7). When the application of the same polarity voltage to the liquid crystal continues for several frames in this manner, for example, flushing (screen flickering) occurs when the polarity inversion of the liquid crystal application voltage is next performed, so that a viewer may be made to feel discomfort to the display. In contrast, in the present modification, for example, when the polarity bias value becomes “−5”, not only the positive polarity voltage but also the negative polarity voltage is applied to the liquid crystal during the period while the polarity bias value changes from “−5” to “0”. Therefore, according to the present modification, the same polarity voltage is prevented from being applied to the liquid crystal continuously for a long time. Thus, the viewer is suppressed from feeling discomfort to the display.

### 2. Second Embodiment

A second embodiment of the present invention will be described. In the following description, points different from the first embodiment will be mainly described, and a description of points similar to the first embodiment will be omitted.

<2.1 Configuration of Display Control Circuit>

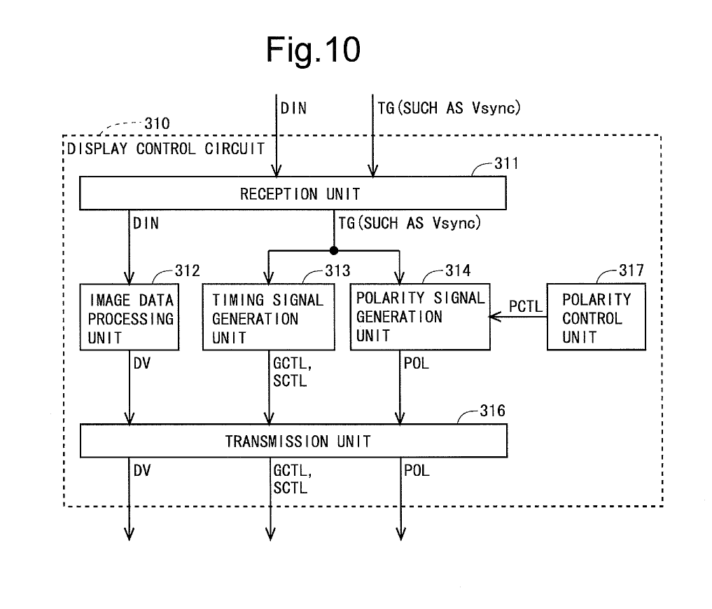

FIG. 10 is a block diagram illustrating a configuration of a display control circuit 310 according to the present embodiment. The display control circuit 310 includes a reception unit 311, an image data processing unit 312, a timing signal generation unit 313, a polarity signal generation unit 314, a polarity control unit 317, and a transmission unit 316. The reception unit 311, the image data processing unit 312, the timing signal generation unit 313, and the transmission unit 316 operate in the same manner as in the first embodiment.

The polarity control unit 317 outputs a polarity control signal PCTL that is a signal indicating the polarity of the liquid crystal application voltage and is a signal for controlling the generation of the polarity signal POL in the polarity signal generation unit 314. The polarity control signal PCTL is set such that a period of indicating the positive polarity and a period of indicating the negative polarity appear alternately with the same length. In the present embodiment, the polarity control signal PCTL includes a positive polarity control signal PCTL(p) for indicating the positive polarity and a negative polarity control signal PCTL(m) for indicating the negative polarity. Then, during the period of instructing the positive polarity, the polarity control unit 317 sets the level of the positive polarity control signal PCTL(p) to the high level and sets the level of the negative polarity control signal PCTL(m) to the low level. During the period of indicating the negative polarity, the polarity control unit 317 sets the level of the negative polarity control signal PCTL(m) to the high level and sets the level of the positive polarity control signal PCTL(p) to the low level.

The polarity signal generation unit 314 generates the polarity signal POL on the basis of the vertical synchronization signal Vsync included in the timing signal group TG and the polarity control signal PCTL outputted from the polarity control unit 317. Specifically, if the positive polarity control signal PCTL(p) is at the high level at the time when the vertical synchronization signal Vsync is inputted, then the polarity signal generation unit 314 sets the level of the polarity signal POL to the high level, and if the negative polarity control signal PCTL(m) is at the high level at that time, then the polarity signal generation unit 314 sets the level of the polarity signal POL to the low level. In the present embodiment, when the levels of the positive polarity control signal PCTL(p) and the negative polarity control signal PCTL(m) are changed at the same timing as the input of the vertical synchronization signal Vsync, the level of the polarity signal POL is determined depending on one of the positive polarity control signal PCTL(p) and the negative polarity control signal PCTL(m), of which level is high after the input of the vertical synchronization signal Vsync. As described above, the polarity signal generation unit 314 generates the polarity signal POL on the basis of the signal value of the polarity control signal PCTL outputted from the polarity control unit 317, the signal value being at the disclosing time of each frame.

In the present embodiment, the polarity signal generation unit 314 and the polarity control unit 317 realize the polarity adjustment unit. That is, the display control circuit 310 in the present embodiment includes the polarity signal generation unit 314 and the polarity control unit 317 as the polarity adjustment unit configured to adjust the polarity of the liquid crystal application voltage so as to suppress an increase in the polarity time difference that is a difference between the length of the period during which the positive polarity voltage is applied to the liquid crystal and the length of the period during which the negative polarity voltage is applied to the liquid crystal.

<2.2 Polarity Control Method>

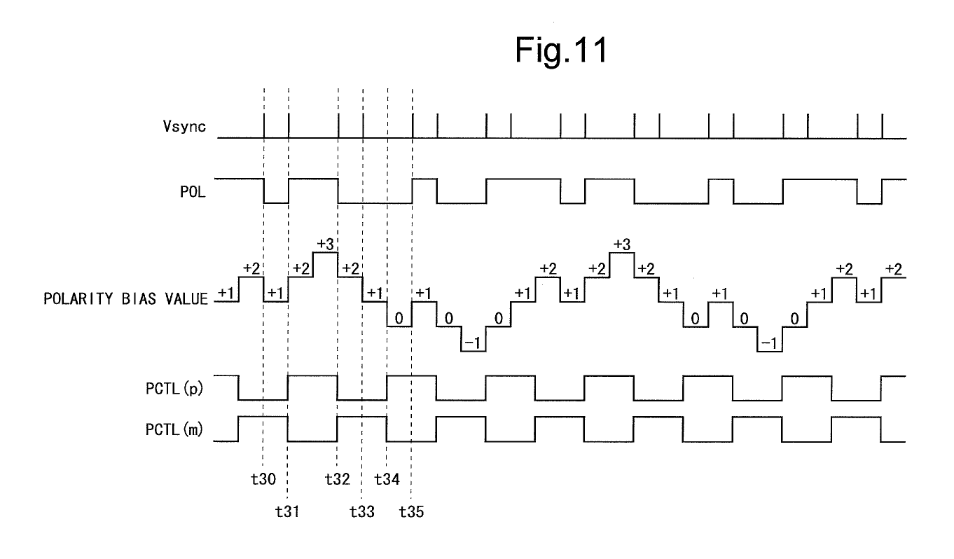

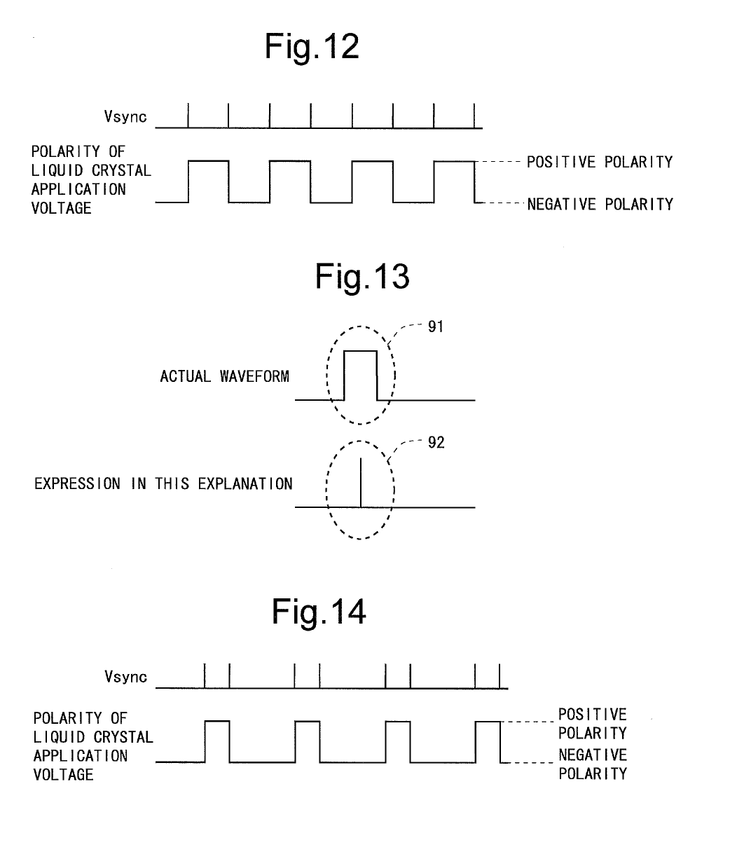

A specific example of such a polarity control method in the present embodiment will be described with reference to FIG. 11. As in the first embodiment, it is assumed that the vertical synchronization signal Vsync is inputted such that the short frame and the long frame are alternately repeated. Moreover, it is assumed that the polarity control unit 317 inverts the levels of the positive polarity control signal PCTL(p) and the negative polarity control signal PCTL(m) every period corresponding to twice the length of the short frame.

Before a time point t30, the level of the polarity signal POL is at the high level. At the time point t30, the vertical synchronization signal Vsync is inputted. At this time, the level of the negative polarity control signal PCTL(m) is at the high level. Therefore, the polarity signal generation unit 314 inverts the level of the polarity signal POL from the high level to the low level.

Thereafter, at a time point t31, the vertical synchronization signal Vsync is inputted. At this time, the level of the positive polarity control signal PCTL(p) changes from the low level to the high level. Therefore, the polarity signal generation unit 314 inverts the level of the polarity signal POL from the low level to the high level. Next, at a time point t32, the vertical synchronization signal Vsync is inputted. At this time, the level of the negative polarity control signal PCTL(m) changes from the low level to the high level. Therefore, the polarity signal generation unit 314 inverts the level of the polarity signal POL from the high level to the low level.

Thereafter, at a time point t33, the vertical synchronization signal Vsync is inputted. At this time, the level of the negative polarity control signal PCTL(m) is at the high level. Therefore, the level of the polarity signal POL is maintained at the low level. At a time point t34, although the levels of the positive polarity control signal PCTL(p) and the negative polarity control signal PCTL(m) are inverted, the vertical synchronization signal Vsync is not inputted, and accordingly, the level of the polarity signal POL is maintained at the low level.

Thereafter, at a time point t35, the vertical synchronization signal Vsync is inputted. At this time, the level of the positive polarity control signal PCTL(p) is at the high level. Therefore, the polarity signal generation unit 314 inverts the level of the polarity signal POL from the low level to the high level.

Likewise, also after the time point t35, the polarity signal generation unit 314 controls the level of the polarity signal POL depending on the level of the polarity control signal PCTL at the time when the vertical synchronization signal Vsync is inputted. As a result, as understood from FIG. 11, the bias in the polarity of the liquid crystal application voltage is suppressed from increasing.

<2.3 Effect>

According to the present embodiment, in the display control circuit 310 of the liquid crystal display device 1, there are provided: the polarity control unit 317 configured to output the polarity control signal PCTL that is a signal indicating the polarity of the liquid crystal application voltage and is set such that the period of indicating the positive polarity and the period of indicating the negative polarity appear alternately with the same length; and the polarity signal generation unit 314 configured to generate the polarity signal POL on the basis of the signal value of the polarity control signal PCTL outputted from the polarity control unit 317, the signal value being at the disclosing time of each frame. That is, the level of the polarity signal POL for controlling the polarity of the liquid crystal application voltage is determined on the basis of the polarity control signal PCTL being set such that the period of indicating the positive polarity and the period of indicating the negative polarity alternately appear with the same length. For this reason, the polarity inversion of the liquid crystal application voltage is performed before the bias in the polarity of the liquid crystal application voltage increases. Therefore, even when the frame frequency is changed in accordance with the change in the input frequency of the input image data DIN, the occurrence of the large bias in the polarity of the liquid crystal application voltage due to the variation in the length of the frame is suppressed. From the above, according to the present embodiment, the occurrence of the burn-in caused by the bias in the polarity of the liquid crystal application voltage is suppressed effectively in the liquid crystal display device 1 configured to display the image while changing the frame frequency.

### 3. Others

The present invention is not limited to each of the above-described embodiments (including the modification), and various modifications can be made without departing from the scope of the present invention. For example, the display control circuit 310 is not limited to the configurations illustrated in FIG. 1 and FIG. 10 as long as the display control circuit 310 has a configuration including the polarity adjustment unit configured to adjust the polarity of the liquid crystal application voltage so as to suppress the increase in the polarity time difference.

This application claims priority to Japanese Patent Application No. 2016-061171 filed on Mar. 25, 2016, under title of “Liquid Crystal Display Device and Method of Controlling the Same”, the contents of which are incorporated herein by reference.

### DESCRIPTION OF REFERENCE CHARACTERS

1: LIQUID CRYSTAL DISPLAY DEVICE

10: LIQUID CRYSTAL PANEL

20: LIQUID CRYSTAL PANEL DRIVE CIRCUIT

30: TCON BOARD

100: DISPLAY UNIT

210: GATE DRIVER

220: SOURCE DRIVER

310: DISPLAY CONTROL CIRCUIT

312: IMAGE DATA PROCESSING UNIT

313: TIMING SIGNAL GENERATION UNIT

314: POLARITY SIGNAL GENERATION UNIT

315: POLARITY MONITORING UNIT

317: POLARITY CONTROL UNIT

PCTL: POLARITY CONTROL SIGNAL

POL: POLARITY SIGNAL

PS: POLARITY MAINTENANCE SIGNAL

Vsync: VERTICAL SYNCHRONIZATION SIGNAL

1. A liquid crystal display device having a liquid crystal panel including a liquid crystal as a display element, the liquid crystal display device being configured to display an image while changing a frame frequency depending on a change in an input frequency of input image data, the liquid crystal display device comprising:
a display control circuit configured to generate, based on the input image data, a video signal representing an image to be displayed on the liquid crystal panel, and configured to generate, depending on the input frequency of the input image data, a control signal including a polarity signal for controlling a polarity of a liquid crystal application voltage; and
a liquid crystal panel drive circuit configured to drive the liquid crystal panel such that a voltage corresponding to the video signal is applied to the liquid crystal, based on the video signal and the control signal that are generated by the display control circuit,
wherein the display control circuit includes a polarity adjustment unit configured to adjust the polarity of the liquid crystal application voltage so as to suppress an increase in a polarity time difference that is a difference between a length of a period during which a positive polarity voltage is applied to the liquid crystal and a length of a period during which a negative polarity voltage is applied to the liquid crystal.

2. The liquid crystal display device according to claim 1, wherein the polarity adjustment unit includes:
a polarity monitoring unit configured to monitor the polarity signal given to the liquid crystal panel drive circuit to obtain the polarity time difference, and to output a monitoring result based on the obtained polarity time difference; and
a polarity signal generation unit configured to generate the polarity signal such that the increase in the polarity time difference is suppressed, based on the monitoring result outputted from the polarity monitoring unit.

3. The liquid crystal display device according to claim 2, wherein
when the polarity time difference becomes equal to or more than a first predetermined value, the polarity monitoring unit gives a polarity maintenance signal as the monitoring result to the polarity signal generation unit throughout a period at least until the polarity time difference becomes equal to or less than a second predetermined value, the polarity maintenance signal issuing an instruction to maintain the liquid crystal application voltage at one of a positive polarity and a negative polarity so as to reduce the polarity time difference, and
upon receiving the polarity maintenance signal, the polarity signal generation unit generates the polarity signal such that the voltage of the polarity indicated by the polarity maintenance signal is applied to the liquid crystal.

4. The liquid crystal display device according to claim 2, wherein
when the polarity time difference becomes equal to or more than a first predetermined value, the polarity monitoring unit intermittently gives a polarity maintenance signal as the monitoring result to the polarity signal generation unit during a period at least until the polarity time difference becomes equal to or less than a second predetermined value, the polarity maintenance signal issuing an instruction to maintain the liquid crystal application voltage at one of a positive polarity and a negative polarity so as to reduce the polarity time difference, and
upon receiving the polarity maintenance signal, the polarity signal generation unit generates the polarity signal such that the voltage of the polarity indicated by the polarity maintenance signal is applied to the liquid crystal.

5. The liquid crystal display device according to claim 2, wherein the polarity monitoring unit obtains the polarity time difference at a frequency higher than a frame frequency.

6. The liquid crystal display device according to claim 1, wherein timing at which a signal value of the polarity signal changes is synchronized with a vertical synchronization signal indicating timing of rewriting a display image on the liquid crystal panel.

7. The liquid crystal display device according to claim 1, wherein the polarity adjustment unit includes:
a polarity control unit configured to output a polarity control signal that is a signal indicating the polarity of the liquid crystal application voltage and being set such that a period of indicating the positive polarity and a period of indicating the negative polarity appear alternately with a same length; and
a polarity signal generationconfigured to generate the polarity signal based on a signal value of the polarity control signal at a start time of each frame.

8. A method for controlling a liquid crystal display device having a liquid crystal panel including a liquid crystal as a display element, the liquid crystal display device being configured to display an image while changing a frame frequency depending on a change in an input frequency of input image data, the method comprising:
a display control step of generating, based on the input image data, a video signal representing an image to be displayed on the liquid crystal panel, and generating, depending on the input frequency of the input image data, a control signal including a polarity signal for controlling a polarity of a liquid crystal application voltage; and
a liquid crystal panel drive step of driving the liquid crystal panel such that a voltage corresponding to the video signal is applied to the liquid crystal, based on the video signal and the control signal that are generated in the display control step,
wherein the display control step includes a polarity adjustment step of adjusting the polarity of the liquid crystal application voltage so as to suppress an increase in a polarity time difference that is a difference between a length of a period during which a positive polarity voltage is applied to the liquid crystal and a length of a period during which a negative polarity voltage is applied to the liquid crystal.
